(19) United States
(12) Patent Application Publication
(10) Pub. No.: US 2025/0218145 A1
(43) Pub. Date: Jul. 3, 2025

(54) Automated Recipe Generation

(71) Applicant: VINST LTD., Kiryat Ono (IL)

(72) Inventors: Assaf Glazer, Kiryat Ono (IL); Chen Fisher, Mishmarot (IL); Shira Zioni, Kadima Zoran (IL)

(21) Appl. No.: 18/848,527

(22) PCT Filed: May 2, 2023
(86) PCT No.: PCT/IB2023/054541

§ 371 Date: Sep. 19, 2024

Related U.S. Application Data
(60) Provisional application No. 63/338,033, filed on May 4, 2022.

(51) Int. Cl. G06V 10/12; A47J 36/00; F16M 11/04; F16M 11/10; F16M 11/20; G06V 10/764; G06V 20/68; G06V 20/70; H04N 23/54; H04N 23/56; H04N 23/695

(52) U.S. Cl. CPC G06V 10/12; A47J 36/00; F16M 11/041; F16M 11/045; F16M 11/10; F16M 11/2064; G06V 10/764; G06V 20/68; G06V 20/70; H04N 23/54; H04N 23/56; H04N 23/695; F16M 2200/04

(57) ABSTRACT

A method for recipe generation includes providing a stand (24, 50), which is configured to hold a camera (30) in a location above or alongside a cooking surface (32), whereby the camera is positioned to capture images of the cooking surface. Image data from images of the cooking surface captured by the camera that is held in the stand during preparation of food on the cooking surface are analyzed by a computer (44) to identify a set of ingredients (36) and a sequence of cooking operations using the ingredients in the preparation of the food. The computer outputs a recipe comprising multiple steps and identifying the ingredients and cooking operations applied in each step.

### CROSS-REFERENCE TO RELATED APPLICATION

This application claims the benefit of U.S. Provisional Patent Application 63/338,033, filed May 4, 2022, which is incorporated herein by reference.

### FIELD OF THE INVENTION

The present invention relates generally to food preparation, and particularly to methods and systems for automating the process of generating cooking recipes.

### BACKGROUND

Mobile telephones have changed the way people cook. Surveys show that most home cooks search for recipes on the Internet and then read the recipes from their mobile telephone, rather than from a cookbook. Many home cooks (as well as professional cooks and food bloggers) use their telephone cameras to take pictures of the food that they make and share the pictures with friends and followers.

### SUMMARY

Embodiments of the present invention that are described hereinbelow provide systems, methods, and software for integration of mobile electronic devices in the kitchen environment.

There is therefore provided, in accordance with an embodiment of the invention, a method for recipe generation, which includes providing a stand, which is configured to hold a camera in a location vertically above a cooking surface, whereby the camera is positioned to capture images of the cooking surface. Image data are received from images of the cooking surface captured by the camera that is held in the stand during preparation of food on the cooking surface. A computer analyzes the image data to identify a set of ingredients and a sequence of cooking operations using the ingredients in the preparation of the food. The computer outputs a recipe including multiple steps and identifying the ingredients and cooking operations applied in each step.

In a disclosed embodiment, the stand is configured so as to enable the camera, while held by the stand, to capture the images along an optical axis that is perpendicular or parallel to a plane of the cooking surface. Additionally or alternatively, the stand includes a mount for the camera, wherein the mount is configured to tilt and shift so as to enable the camera to capture the images from different angles and locations relative to the cooking surface.

In one embodiment, the stand includes lights for illuminating the cooking surface. Additionally or alternatively, the stand includes a fan configured to ventilate the camera.

In some embodiments, the stand is configured to hold a mobile device in which the camera is embedded. In a disclosed embodiment, receiving the stream of image data includes receiving the image data in the computer by communication over a network with the mobile device, and outputting the recipe includes transmitting recipe information from the computer over the network to a monitor at a location of the cooking surface.

In a disclosed embodiment, analyzing the image data includes applying labels to the ingredients and the cooking operations by a classification program running on the computer, and outputting the recipe includes displaying the labels applied by the classification program, wherein the method includes receiving an input from a user of the recipe correcting one of the displayed labels, and updating the classification program responsively to the input.

Additionally or alternatively, analyzing the image data includes identifying, during each cooking operation, a location in which the cooking operation is carried out and/or identifying, in one or more of the cooking operations, a tool used in the cooking operation.

In some embodiments, the method includes storing a corpus of rules indicating dependencies between different ingredients, dependencies between different operations, and dependencies between given operations and the ingredients used in each of the given operations, and outputting the recipe includes applying the dependencies in organizing and correcting the steps of the recipe. Additionally or alternatively, the method includes storing a library of cooking practices, and outputting the recipe includes making a comparison between the identified sequence of cooking operations and the cooking practices in the library, and outputting a suggested modification to the recipe based on the comparison.

In a disclosed embodiment, the method includes receiving in the computer inputs made by a user to edit the recipe, and publishing the edited recipe.

In some embodiments, analyzing the image data includes inputting media assets, including the image data, to a Generative Artificial Intelligence (AI) engine, which outputs the recipe. In one embodiment, outputting the recipe includes adding, by the Generative AI engine, a step to the recipe that was absent from the media assets that were input to the computer. Additionally or alternatively, outputting the recipe includes suggesting, by the Generative AI engine, a correction or improvement to the recipe.

In a disclosed embodiment, the stand includes a mount for the mobile device, which is configured to hold the mobile device stably in at least a first position in which a camera of the mobile device is positioned to capture images of the cooking surface and a second position in which the mobile device is rotated to enable a user to interact with a touchscreen of the mobile device.

There is also provided, in accordance with an embodiment of the invention, a stand for a mobile device, which includes a camera and a touchscreen. The stand includes a pedestal, including a base for placement on a surface and a turntable configured to rotate on the base. A strut protrudes upward from the pedestal. A telescopic arm has a first end attached by a hinge to the strut so that the telescopic arm swivels on the hinge. A mount for the mobile device is attached by an articulating joint to a second end of the telescopic arm and is configured to hold the mobile device stably in at least a first position in which the camera is positioned to capture images of the surface and a second position in which the mobile device is rotated to enable a user to interact with the touchscreen.

In a disclosed embodiment, in the first position the mobile device is horizontal, and in the second position the mobile device is vertical.

Additionally or alternatively, the pedestal includes a counterweight, which is mounted on the turntable opposite the vertical strut.

Further additionally or alternatively, the pedestal includes a scale indicating an angle of rotation of the pedestal relative to the surface.

In a disclosed embodiment, the stand includes a stylus, which is held on the stand and configured for interaction with the touchscreen.

Additionally or alternatively, the mount includes a communication chip for communicating with the mobile device.

In some embodiments, the stand includes one or more lights for illuminating the surface and/or a fan configured to ventilate the camera.

There is additionally provided, in accordance with an embodiment of the invention, a computer software product, including a computer-readable medium in which program instructions are stored. The instructions, when read by a computer, cause the computer to receive a stream of image data from images captured by a camera that is held over a cooking surface during preparation of food on the cooking surface, to analyze the image data to identify a set of ingredients and a sequence of cooking operations using the ingredients in the preparation of the food, and to output a recipe including multiple steps and identifying the ingredients and cooking operations applied in each step.

The present invention will be more fully understood from the following detailed description of the embodiments thereof, taken together with the drawings in which:

### BRIEF DESCRIPTION OF THE DRAWINGS

FIG. 1 is a schematic pictorial illustration of a system for recipe generation, in accordance with an embodiment of the invention;

FIG. 2 is a schematic pictorial illustration showing a stand for a mobile telephone, in accordance with an embodiment of the invention;

FIG. 3 is a schematic detail view of the base of the stand of FIG. 2;

FIG. 4 is a schematic pictorial illustration showing another view of the stand of FIG. 2;

FIG. 5 is a flow chart that schematically illustrates a method for recipe generation, in accordance with an embodiment of the invention; and

FIG. 6 is a graph that schematically illustrates a machine learning model that is used in recipe generation, in accordance with an embodiment of the invention.

### DETAILED DESCRIPTION OF EMBODIMENTS

### Overview

Technology has changed the way we cook. In particular, mobile devices, such as smartphones and tablets, have become indispensable tools in home food preparation. For example, cooks use their mobile devices to access recipes and search for information, as well as making notes for future reference. Many home cooks take pictures of food in various stages of preparation, both for their own use in recreating their recipes in the future and to share, particularly via social media.

Despite all these useful capabilities, the experience of using a mobile device in the kitchen is far from optimal. Home cooks need a place to keep their smartphones safe and handy while cooking, while enabling easy access to applications used in the kitchen, such as cooking blogs, direct messaging, video and voice calls, and music. Cooks should be able to take pictures and videos of the ingredients and cooking operations; to produce lists and verbal records of the ingredients and cooking operations; and to record “food stories”-visual recipes that they can use themselves and share with others. There is a need for tools that can automate and enhance these processes, to enable convenient integration of mobile devices into the kitchen environment.

Embodiments of the present invention address this need by providing a system that combines hardware and software components to facilitate access to mobile devices and exploitation of their capabilities in the kitchen. The hardware includes a stand that enables the mobile device to capture images of the cooking process from any desired perspective, including particularly a bird's eye view, i.e., a perspective on or near the vertical axis above the cooking surface. The software includes an application that is installed on users' mobile devices and communicates with a server that uses artificial intelligence (AI) in analyzing the images and automatically documenting the steps in recipes for food preparation.

The stand is positioned on a cooking surface, for example on a countertop, and includes a mount for the user's mobile telephone. The stand is adjustable in height and viewing angle, enabling the mobile telephone to be held in a location vertically above the cooking surface, from which the camera that is embedded in the telephone is able to capture images of the cooking surface from a bird's-eye view, for example along an optical axis perpendicular to the plane of the cooking surface or possibly tilted relative to this axis. (Alternatively, the mount can be made to accommodate other sorts of video cameras with suitable digital outputs.) In some embodiments, the user is able to adjust the stand to view and use the touchscreen of the telephone without removing the telephone from its mount, and then return the telephone to its precise previous location to continue taking pictures. The stand may also hold a stylus to allow the user to interact with the touchscreen even while the user's hands are dirty or wet. The stand can be folded and stored with a minimal footprint on the countertop or elsewhere.

In some embodiments the stand includes other accessories. For example, a Near Field Communication (NFC) chip may be embedded in the mount to call up a dedicated cooking application and keep the telephone screen on while the telephone is in the mount. As another example, a fan may be attached to the stand to ventilate the camera and thus prevent steam from fogging the camera lens and blocking its field of view (particularly when the stand is positioned over a cooking stove). Additionally or alternatively, lights, such as LEDs, may be attached to the stand to illuminate the cooking surface. As another alternative, the lights and/or fan may be provided on a separate mount. Cabling may be provided in the stand to power the fan and/or lights, as well as charging the mobile telephone.

In addition to the mobile telephone that is mounted to the stand, some embodiments of the present invention use a monitor, such as a tablet computer, to enable the user to monitor the cooking process while cooking and interacting with the software application. Image data output by the camera can be displayed on the monitoring device in real time. Optionally, one or more additional cameras may be used for video streaming from different viewpoints. The user can start, stop, pause, and manage the recording of the cooking process using the monitor. The mobile telephone is held in a quick-release mount, enabling the user to detach the mobile telephone from the stand while cooking, to take extra shots and/or use the telephone for other purposes, and then to attach the mobile telephone back in the same viewpoint.

A computer receives and analyzes the image data captured by the mobile telephone. The computer that performs this function may be local, for example the mobile telephone that is used to capture the images or the same tablet computer that is used as the monitor, or it may be a remote server, which receives the image data over a network. The computer applies AI software in identifying the set of ingredients and the sequence of cooking operations that were employed by the user in preparing the food that is to be the subject of the recipe. The AI learning model can be trained to extract information from various perspectives, including both the bird's-eye view and lower angles.

The computer automatically outputs a recipe, which comprises multiple steps and identifies the ingredients and cooking operations applied in each step. In some embodiments, a Generative AI engine arranges the images that were captured during a process of food preparation into a “food story,” i.e., a recipe that uses pictures and text to document and describe the process. The software application running on the mobile telephone or tablet enables the user to select the images and video clips that are to go into the food story, and then to edit and publish the recipe that the AI engine has produced. The AI engine may supplement the user's selections with additional images captured in the course of the process of food preparation, as well as with information from other sources, such as recipes that the user accessed online while preparing the food and previous recipes made by the same user. In some embodiments, a classification program running on the computer applies labels to the ingredients and cooking operations in each step, and the user is able to edit and correct these labels. The computer updates the classification program on the basis of these user inputs, thus improving the accuracy of classification over time in an ongoing process of active learning.

### First Embodiment

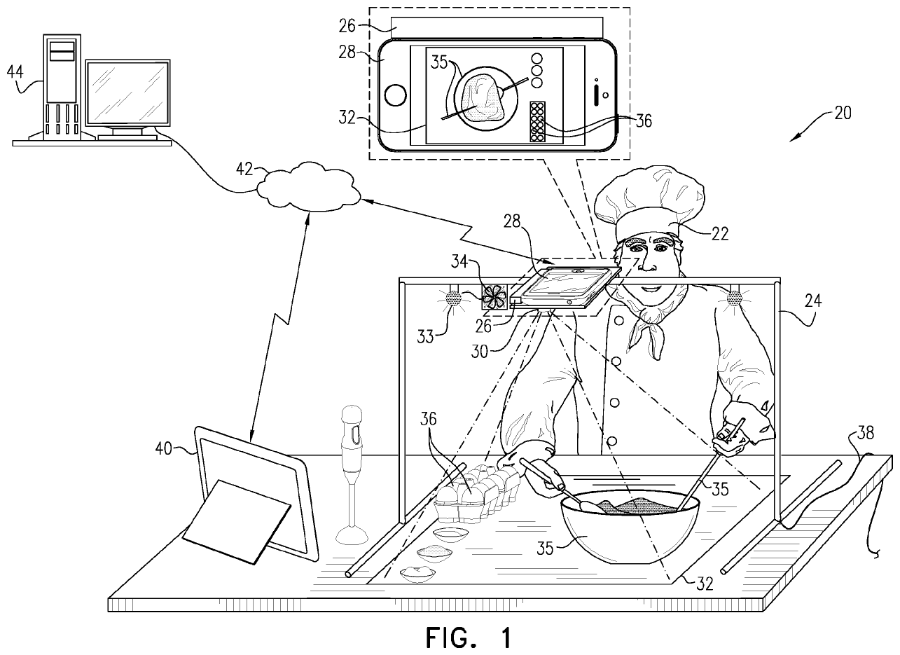

FIG. 1 is a schematic pictorial illustration of a system 20 for automated recipe generation, in accordance with an embodiment of the invention. In the pictured scenario, system 20 is assisting a user 22 in documenting a process of food preparation.

A stand 24 is placed over a cooking surface 32, such as a counter or stove top. Stand 24 comprises a mount 26, which holds a mobile telephone 28 in a location vertically above cooking surface 32, whereby a camera 30 in the mobile telephone is positioned to capture images of the cooking surface. Mobile telephone 28 may be positioned to capture images of cooking surface in either portrait mode (as shown in FIG. 1) or landscape mode (rotated by 90° relative to the position in the figure). Mount 26 may include insulation to protect mobile telephone 28 from heat and steam. In the pictured example, stand 24 is configured such that camera 30 captures the images along an optical axis that is perpendicular to the plane of cooking surface 32. Alternatively, mount 26 may be tilted and/or slid along stand 24 to enable camera 30 to capture images at different angles and locations. Stand 24 also comprises lights 33, such as LEDs, for illuminating the cooking surface and a fan 34 configured to ventilate the camera. A cable 38, such as a USB cable, provides power to the lights, fan, and mobile telephone.

Mobile telephone 28 outputs image data based on images of cooking surface 32 captured by camera 30 during preparation of food on the cooking surface. The images typically include tools 35 and ingredients 36 that are assembled and employed by user 22 in each step of the cooking process. In the pictured embodiment, the images are presented locally on a monitor 40, such as on the screen of a tablet computer, and the image data are also transmitted over a network 42, such as the Internet, to a remote computer, such as a server 44. Server 44 applies an image classification program in order to identify tools 35 and ingredients 36, as well as the sequence of cooking operations using the ingredients in the preparation of the food and the location and products of each operation. Upon completion of the cooking process, server 44 outputs a recipe over network 42 to monitor 40, in which the cooking process is divided into steps and the ingredients and cooking operations applied in each step are identified.

Mobile telephone 28 and server 44 carry out the operations that are described herein under the control of program instructions that are coded in software. The software may be downloaded to the telephone and to the server in electronic form, for example over a network. Additionally or alternatively, the software may be stored on tangible, non-transitory computer-readable media, such as optical, magnetic, or electronic memory media.

### Second Embodiment

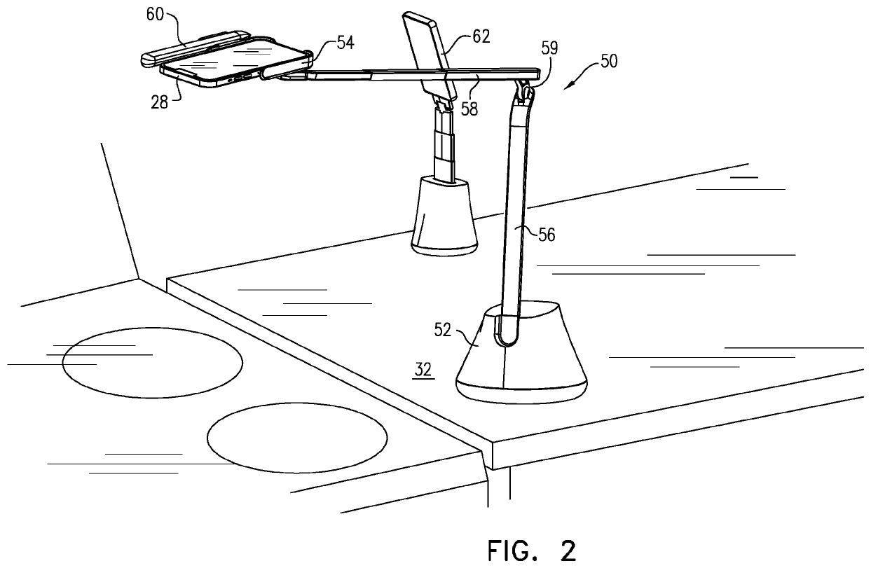

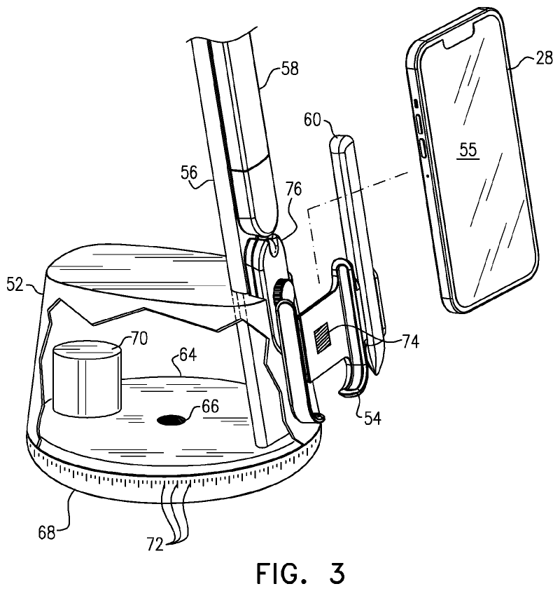

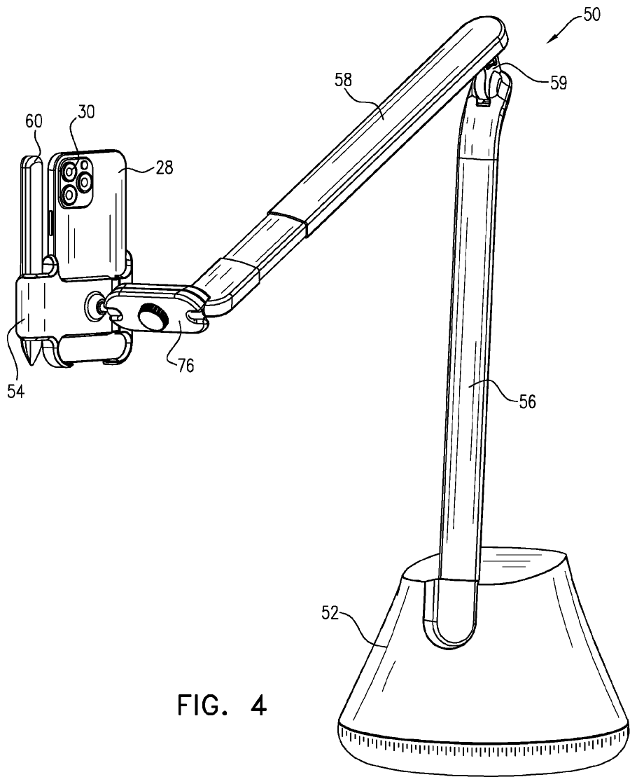

Reference is now made to FIGS. 2-4, which are schematic pictorial illustrations of a stand 50 for mobile telephone 28, in accordance with an embodiment of the invention. Stand 50 functions as a sort of “digital hub,” enabling telephone 28 to be used conveniently for a number of purposes while the user of the telephone is cooking. FIG. 2 shows stand 50 positioned for capturing images in a kitchen environment. FIG. 3 is a detail, partly cutaway view of a pedestal 52 and a mount 54 in stand 50. FIG. 4 shows stand 50 positioned to facilitate user interaction with telephone 28. Stand 50 may be used in system 20, for example, in place of stand 24, either together with monitor 40 or with a touchscreen 55 of telephone 28 serving as the monitor.

Mount 50 comprises a strut 56 protruding upward from pedestal 52, with a telescopic arm 58 connected to strut 56 by a friction hinge 59, so that arm 58 is able to swivel and then hold its position after being set by the user. Mount 54 is attached to the end of telescopic arm 58 by an articulating joint 76, which can likewise be set to hold its position. Thus, in FIG. 2, mount 50 is positioned so that the camera in telephone 28 is able to capture images of the cooking surface beneath it, while in FIGS. 3 and 4 telephone 28 is rotated to enable the user to interact with touchscreen 55 of the telephone. In FIG. 2 telephone 28 is roughly horizontal and captures images along a vertical axis, while in FIG. 4, telephone 28 is roughly vertical and can capture images along a horizontal axis. A stylus 60 is held in mount 54 alongside telephone 28, so that the user can interact with touchscreen 55 using the stylus in place of his or her fingers. A floodlight 62 is optionally positioned alongside the cooking surface to improve the quality of the images captured by camera 30.

As can be seen in FIG. 3, pedestal 52 contains a turntable 64, which is mounted on a base 68 by a rotating joint 66. Vertical strut 56 is mounted on turntable 64, with a counterweight 70 on the turntable opposite strut 56, so that pedestal 52 remains stable as arm 58 is extended. A scale, such as hashmarks 72 on base 68, enables the user to rotate stand 50, for example between the positions shown in FIGS. 2 and 4, and then return the stand precisely to its previous position.

An NFC chip 74 is embedded in mount 54 and interacts with the NFC transceiver in telephone 28 when the telephone is placed in the mount. For example, NFC chip 74 may invoke a dedicated cooking application on telephone, which assists the user in accessing recipes and in documenting the user's food preparation. While telephone 28 is in mount 54, the telephone screen remains on. The use and operation of the cooking application in documenting and generating recipes are described below.

### Methods for Recipe Generation

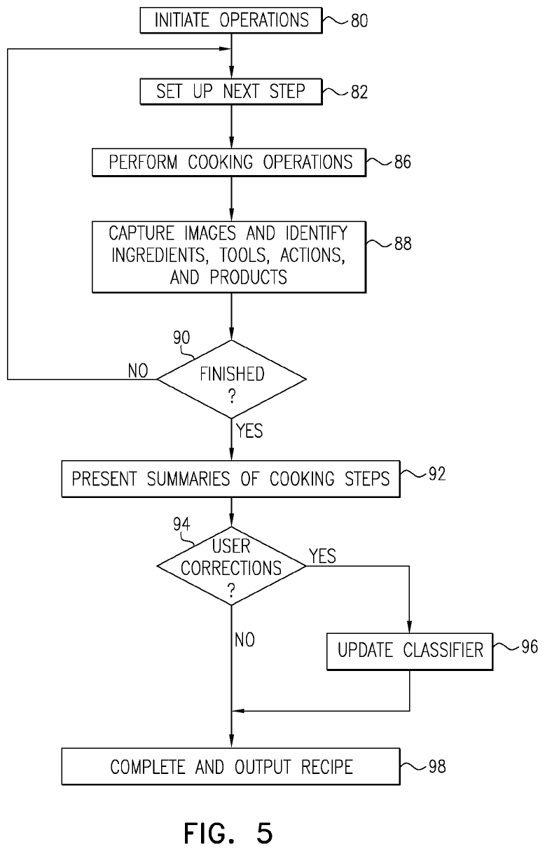

FIG. 5 is a flow chart that schematically illustrates a method for recipe generation, in accordance with an embodiment of the invention. The method is assumed to be carried out using the components shown in the preceding figures, although other hardware configurations may alternatively be used, mutatis mutandis.

User 22 initiates the method by interacting with the software application, for example using touch screen 55 of telephone 28 or using monitor 40, at an initiation step 80. The user then proceeds to prepare the dish that will be the subject of the recipe in a sequence of stages. In each stage, user 22 arranges the ingredients that will be required in the next cooking operation, possibly including ingredients that were prepared in preceding stages, at a setup step 82. User 22 then performs a cooking operation using the ingredients, at a cooking step 86. Although steps 82 and 86 are shown as occurring in sequence (which is the practice that experienced cooks generally follow), the method of FIG. 5 can also be applied when setup and cooking are more closely interleaved.

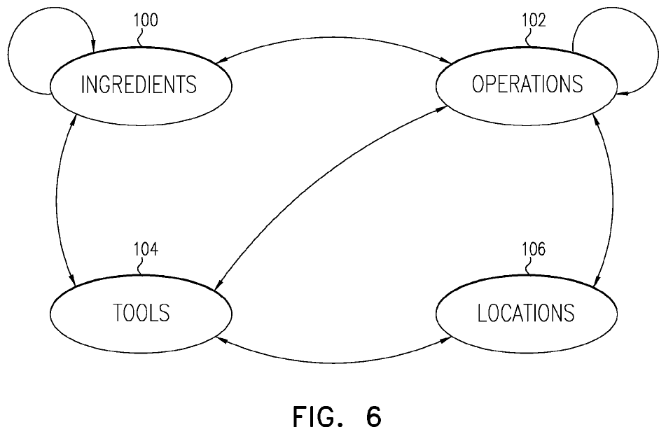

In each stage of the cooking process, camera 30 in telephone 28 captures images of the ingredients and operation in progress, at an image capture step 88. (It is possible, however, that not all stages of the process are captured, in which case a Generative AI engine may be used to fill in missing information, as described further hereinbelow.) Server 44 processes the images to identify and apply labels to the ingredients in the images, as well as to identify actions performed by the user. Typically, this analysis also identifies the location in which the cooking operation is carried out, the products of the cooking operation, and tools (if any) that are used in the cooking operation. In analyzing the images and resolving uncertainties, server 44 may apply a corpus of rules indicating, for example, dependencies between different ingredients, dependencies between different operations, and dependencies between given operations and the ingredients used in each of the given operations. A model of these sorts of rules is described hereinbelow with reference to FIG. 6. The rules may be explicit, or they may be embodied implicitly in the AI framework applied by the computer, for example in the coefficients of a neural network that has been trained over a range of recipes and cooking scenarios.

The process of setting up and performing successive steps of food preparation continues until user 22 indicates that he or she has finished preparing the food, at a preparation completion step 90. At this point, server 44 outputs a recipe comprising summaries of the cooking steps and identifying the ingredients and cooking operations applied in each step, at a recipe generation step 92. Server 44 may also suggest possible alternatives and improvements to the recipe. For example, server 44 may store a library of cooking practices, and may compare the sequence of cooking operations that it has identified to the cooking practices in the library. (The library may be stored explicitly, or it may, alternatively or additionally, be embedded in the training set of a neural network, for example.) Based on this comparison, server 44 may suggest modifications to the recipe, as well as resolving uncertainties in the analysis of one or more of the cooking steps. Alternatively or additionally, a Generative AI model may be used to suggest modifications to the original recipe, based on other related recipes that the model has learned.

User 22 views the recipe on screen 55 or monitor 40 and corrects any erroneous labels that server 44 may have applied to the ingredients or operations performed at any stage, in a correction input step 94. Server 44 adds any such corrections to the set of training data that is used in training the classification programs that were used at step 88, at a classifier update step 96. Corrections of this sort, which are input by many different users, can be applied in periodically retraining the classification program, thus improving classification accuracy over time in a large-scale closed-loop process.

The pseudocode in Listing I below is one example of an implementation of the image analysis operations applied by a computer (such as server 44) in carrying out the method of FIG. 5. The pseudocode illustrates how a problem of recipe analysis is broken into sub-problems and how dependencies can be used to increase precision. The computer first classifies the ingredients and then uses the list of ingredients classified to reduce the search space for classification of operations. This same principle is applied in identifying tools and cooking locations. This example is a “greedy” algorithm, in the sense that it first locks the list of ingredients and assumes this list to be fixed in classifying the operations, tools, and cooking locations.

Alternatively, other algorithmic approaches may be used with different dependency models and using different AI techniques. Another approach based on Generative AI is presented, for example, in Listing II further below.

LISTING I - RECIPE GENERATION

```
recipe CompileRecipe(media m, prior p){
  //Prior information (e.g., previous recipes
  //created by the user) is used to reduce search space
  recipe = new Recipe(p);
  /*classify ingredients, operations, tools, and cooking
  locations for each of the media
  assets*/
  For i = 1 to m.count
    //Use a clustering algorithm to detect a
    //sequence of clips with unique operations
    ops = recipe.operations.Add((m(i));
    //Classify ingredients, product, tools,
    //location, and operation for each of the
    //clusters found in the previous step
    For j = 1 to ops.count
      //classify the list of ingredients,
      //products, tools, and locations for
      //the current operation. Use priors
      //and past classification in recipe to
      //reduce the search space.
      ops(j).ClassifyIng(recipe);
      ops(j).ClassifyProducts(recipe);
      ops(j).ClassifyTools(recipe);
      ops(j).ClassifyLocs(recipe);
      //Use prior and past classification
      //results to classify the operation type
      ops(j).ClassifyOp(recipe);
  Return recipe;
```

In one embodiment, classifications are applied iteratively for each of the input media assets (such as images and video clips picked by the user). In each iteration, the classification process starts with a clustering algorithm applied simultaneously by the computer over all frames in the current media asset. Each of the clusters detected is a sequence of consecutive frames associated with a specific cooking operation. A multi-categorical classifier (for example, a deep learning neural net classifier) classifies the ingredients, products, and locations in each cluster. Then, these classification results, together with past classifications and other prior knowledge, are used to classify the operation type in each cluster, i.e., in each sequence of frames. This classifier can be implemented using Activity Recognition algorithms.

Returning now to FIG. 5, once user 22 has finished making any necessary corrections, the user is able to edit the recipe using the application program on telephone 28 or monitor 40, at a recipe completion step 98. This step may include adding still and video images from sequences captured by camera 30, as well as adding audio and/or textual comments, for example. Additionally or alternatively, the user may select images and other media (such as audio and/or text) prior to generation of the recipe by the Generative AI engine, for use by the AI engine in generating the recipe. The user may then publish the recipe via server 44, for example, and/or other media platforms.

FIG. 6 is a graph that schematically illustrates an adaptive machine learning model that is used in recipe generation, in accordance with an embodiment of the invention. The model is used by server 44, for example, in analyzing images captured during food preparation in order to resolve uncertainties and improve accuracy in identifying ingredients 100 and operations 102 that are used in each step of a recipe.

The model of FIG. 6 defines dependencies between different ingredients 100 and operations 102, as well as the dependencies of the ingredients and operations on cooking tools 104 and cooking locations 106 that are detected in the images. Thus, for example, analysis and labeling of many different sequences of food preparation will indicate the likelihood of a certain ingredient or operation given the ingredients and operations used previously, as well as the tools and locations that are in use.

In one embodiment, the model of FIG. 6 is used in training a Generative AI engine to compile data from thousands or even millions of different recipes and cooking processes that are input to server 44. This model enables the Generative AI engine to complete parts of recipes that may have been absent from the input media, as well as correcting labels and ignoring certain input parameters that are considered erroneous on the basis of the dependencies that the model has learned.

Listing II below illustrates the operation of a Generative AI engine in compiling a recipe in accordance with another embodiment of the invention. The algorithm embodied in Listing II can also handle situations in which the media assets input to the algorithm do not cover all the relevant cooking operations.

LISTING II - RECIPE GENERATION

```
/*classify ingredients, tools, cooking locations, and
operations sequentially for each of the
media assets in m, and use the results to create the
recipe. Prior information might be added
to reduce search space*/
recipe CompileRecipe(media assets, priors p){
  //Prior information (e.g., previous recipes
  //created by the user) is used to reduce search space
  recipe = new Recipe(p);
  //process the media assets sequentially in
  chronological order
  For i = 1 to assets.count
    //classify the list of ingredients, tools,
    //and locations that were found in the i'th
    //asset. Use past classification in recipe
    to reduce the search space.
    asset = assets(i);
    ingredient = ClassifyIngs(asset,recipe);
    tools = ClassifyTools(asset, recipe);
    locations = ClassifyLocs(asset, recipe);
    //Go over all operations found in the asset
    While(asset =! null)
      //use an activity recognition method
      //to detect the next operation. Use the
      //list of ingredients, tools, and
      //locations in asset, as well as past
      //classifications in recipe, to reduce search space.
      op = RecognizeNextOp(asset,recipe);
      //add operation to the recipe
      recipe.Add(op);
      //Remove the video footage of the
      //operation found from the asset
      //before continuing to the next operation.
      asset.Remove(op. VideoFootage);
  //Run Generative AI model to fix and complete
  //missing operations to generate the full recipe
  recipe = RunGenAI(recipe);
```

The pseudocode above defines the method CompileRecipe, which returns a full recipe given a sequence of media assets (such as images and clips taken by the user while cooking a recipe). The media assets may contain only partial information about the recipe, i.e., it could happen that not all operations in the full recipe were recorded in the media assets chosen by the user.

The sequence of media assets is associated with a chronological sequence of cooking operations that were carried out by the user. Since there may be more than one operation in each media asset, each video clip is broken into a sequence of segments, each corresponding to a given cooking operation, using the RecognizeNextOp method. The RecognizeNextOp method can be implemented using Activity Recognition algorithms. In one embodiment, the method is implemented using a greedy algorithm, which detects operations iteratively starting from the first cooking operation, to the second, and so forth. The algorithm uses a list of ingredients, tools, and locations detected in each asset itself, as well as past classifications found so far in recipe, to reduce the search space.

Depending on the user's choice of media assets to acquire and input to the method, the list of operations detected in the media assets may be incomplete. False and/or redundant classifications may also occur in this list. The RunGenAI method is utilized to correct and complete the missing operations and generate the full recipe. Generative AI models create new data samples given a prompt input. This sort of model may also be used to suggest improvements to the recipe, such as more appropriate ways to carry out certain steps.

In the present embodiment, the RunGenAI method uses a Generative AI model to generate the complete recipe given a prompt list of operations. This functionality can be implemented by training a classifier to produce a recipe given a partial and/or corrupted list of operations. For example, a dataset containing many thousands of recipes can be gleaned from the Internet for training the model. Video recipes with tagged operations can also be used to improve accuracy, by using multimodal learning to handle images and list of operations simultaneously. In addition, active learning can be applied to improve the accuracy of the Generative AI model over time. As noted earlier, Generative AI models can also be used to suggest modifications to an existing recipe, for example by training the classifier to generate a list of similar recipes instead of a single recipe. Generative AI models can also be used to generate synthetic images and video clips for any missing operations.

The use cases described above refer mainly to application of embodiments of the present invention in home cooking scenarios. These embodiments may also be applied, mutatis mutandis, by professional cooks and kitchens. For example, food bloggers may use the hardware and software tools described above in documenting recipes for publication. As another example, restaurants and hotels may use these tools in generating publicity materials and instructions for their cooking staffs. All such applications are considered to be within the scope of the present invention.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for recipe generation, comprising:
providing a stand, which is configured to hold a camera in a location vertically above a cooking surface, whereby the camera is positioned to capture images of the cooking surface;
receiving image data from images of the cooking surface captured by the camera that is held in the stand during preparation of food on the cooking surface;
analyzing the image data by a computer to identify a set of ingredients and a sequence of cooking operations using the ingredients in the preparation of the food; and
outputting from the computer a recipe comprising multiple steps and identifying the ingredients and cooking operations applied in each step.

2. The method according to claim 1, wherein the stand is configured so as to enable the camera, while held by the stand, to capture the images along an optical axis that is perpendicular or parallel to a plane of the cooking surface.

3. The method according to claim 1, wherein the stand comprises a mount for the camera, wherein the mount is configured to tilt and shift so as to enable the camera to capture the images from different angles and locations relative to the cooking surface.

4. The method according to claim 1, wherein the stand comprises lights for illuminating the cooking surface.

5. The method according to claim 1, wherein the stand comprises a fan configured to ventilate the camera.

6. The method according to claim 1, wherein the stand is configured to hold a mobile device in which the camera is embedded.

7. The method according to claim 6, wherein receiving the stream of image data comprises receiving the image data in the computer by communication over a network with the mobile device, and wherein outputting the recipe comprises transmitting recipe information from the computer over the network to a monitor at a location of the cooking surface.

8. The method according to claim 1, wherein analyzing the image data comprises applying labels to the ingredients and the cooking operations by a classification program running on the computer, and wherein outputting the recipe comprises displaying the labels applied by the classification program, and
wherein the method comprises receiving an input from a user of the recipe correcting one of the displayed labels, and updating the classification program responsively to the input.

9. The method according to claim 1, wherein analyzing the image data comprises identifying, during each cooking operation, a location in which the cooking operation is carried out.

10. The method according to claim 1, wherein analyzing the image data comprises identifying, in one or more of the cooking operations, a tool used in the cooking operation.

11. The method according to claim 1, and comprising storing a corpus of rules indicating dependencies between different ingredients, dependencies between different operations, and dependencies between given operations and the ingredients used in each of the given operations, and wherein outputting the recipe comprises applying the dependencies in organizing and correcting the steps of the recipe.

12. The method according to claim 1, and comprising storing a library of cooking practices, and wherein outputting the recipe comprises making a comparison between the identified sequence of cooking operations and the cooking practices in the library, and outputting a suggested modification to the recipe based on the comparison.

13. The method according to claim 1, and comprising receiving in the computer inputs made by a user to edit the recipe, and publishing the edited recipe.

14. The method according to claim 1, wherein analyzing the image data comprises inputting media assets, including the image data, to a Generative Artificial Intelligence (AI) engine, which outputs the recipe.

15. The method according to claim 14, wherein outputting the recipe comprises adding, by the Generative AI engine, a step to the recipe that was absent from the media assets that were input to the computer.

16. The method according to claim 14, wherein outputting the recipe comprises suggesting, by the Generative AI engine, a correction or improvement to the recipe.

17. The method according to claim 1, wherein the stand comprises a mount for the mobile device, which is configured to hold the mobile device stably in at least a first position in which a camera of the mobile device is positioned to capture images of the cooking surface and a second position in which the mobile device is rotated to enable a user to interact with a touchscreen of the mobile device.

18. A stand for a mobile device, which includes a camera and a touchscreen, the stand comprising:
a pedestal, comprising a base for placement on a surface and a turntable configured to rotate on the base;
a strut protruding upward from the pedestal;
a telescopic arm having a first end attached by a hinge to the strut so that the telescopic arm swivels on the hinge; and
a mount for the mobile device, which is attached by an articulating joint to a second end of the telescopic arm and is configured to hold the mobile device stably in at least a first position in which the camera is positioned to capture images of the surface and a second position in which the mobile device is rotated to enable a user to interact with the touchscreen.

19. The stand according to claim 18, wherein in the first position the mobile device is horizontal, and in the second position the mobile device is vertical.

20. The stand according to claim 18, wherein the pedestal comprises a counterweight, which is mounted on the turntable opposite the vertical strut.

21. The stand according to claim 18, wherein the pedestal comprises a scale indicating an angle of rotation of the pedestal relative to the surface.

22. The stand according to claim 18, and comprising a stylus, which is held on the stand and configured for interaction with the touchscreen.

23. The stand according to claim 18, wherein the mount comprises a communication chip for communicating with the mobile device.

24. The stand according to claim 18, and comprising one or more lights for illuminating the surface.

25. The stand according to claim 18, and comprising a fan configured to ventilate the camera.

26. A computer software product, comprising a computer-readable medium in which program instructions are stored, which instructions, when read by a computer, cause the computer to receive a stream of image data from images captured by a camera that is held over a cooking surface during preparation of food on the cooking surface, to analyze the image data to identify a set of ingredients and a sequence of cooking operations using the ingredients in the preparation of the food, and to output a recipe comprising multiple steps and identifying the ingredients and cooking operations applied in each step.
